(19) United States
(12) Patent Application Publication
(10) Pub. No.: US 2018/0322671 A1
(43) Pub. Date: Nov. 8, 2018

(54) METHOD AND APPARATUS FOR VISUALIZING A BALL TRAJECTORY

(71) Applicant: Ji Eul Song, Gyeonggi-do (KR)

(72) Inventor: Ji Eul Song, Gyeonggi-do (KR)

(21) Appl. No.: 15/639,488

(22) Filed: Jun. 30, 2017

(30) Foreign Application Priority Data
May 8, 2017 (KR) 10-2017-0057329

(51) Int. Cl. G06T 11/60; G06T 7/246; G06T 7/292; G06T 5/00

(52) U.S. Cl. CPC G06T 11/60; G06T 7/246; G06T 7/292; G06T 2207/20221; G06T 2207/10016; G06T 2207/30224; G06T 2207/30241; G06T 5/002

(57) ABSTRACT

An apparatus for visualizing a ball trajectory includes a trajectory determination module configured to analyze motion videos of a flying ball captured by a plurality of cameras to determine a trajectory of the flying ball, said trajectory of the flying ball being defined by 3-dimensional coordinates; and an image rendering module configured to render a sequence of images of the ball from a batter's viewpoint based on the 3-dimensional coordinates, said image rendering module being further configured to control different background scenes to be included in the sequence of images of the ball as the ball approaches toward the batter in the sequence of images of the ball.

### CROSS-REFERENCE TO RELATED APPLICATIONS

This application claims the benefit under 35 USC 119(a) of Korean Patent Application No. 10-2017-0057329 filed on May 8, 2017 in the Korean Intellectual Property Office, the entire disclosure of which is incorporated herein by reference for all purposes.

### TECHNICAL FIELD

The following description relates to visualizing a ball trajectory.

### BACKGROUND

With the development of a sports broadcasting system, various technologies have been developed to multidirectionally display the progress of a professional baseball game to a viewer. Such technologies include tracking and visualizing a trajectory of a ball pitched by a pitcher, which may be used for the purpose of television broadcasting and may further be beneficially used to analyze the speed, quality and types of the pitches thrown by a team's pitcher or other competitive team's pitcher in a professional or amateur baseball team.

### SUMMARY

This Summary is provided to introduce some exemplary concepts of the disclosed technology without any intent to limit the disclosed technology. This patent document provides a technique that can be embodied in implementation for visualizing a ball trajectory in a way that gives more realistic view to a viewer as if the viewer is present in the scene.

In one general aspect, an apparatus for visualizing a ball trajectory includes a trajectory determination module configured to analyze motion videos of a flying ball captured by a plurality of cameras to determine a trajectory of the flying ball, said trajectory of the flying ball being defined by 3-dimensional coordinates; and an image rendering module configured to render a sequence of images of the ball from a batter's viewpoint based on the 3-dimensional coordinates, said image rendering module being further configured to control different background scenes to be included in the sequence of images of the ball as the ball approaches toward the batter in the sequence of images of the ball.

The image rendering module may be further configured to overlay the ball over the different background scenes in the sequence of images of the ball.

The trajectory determination module may be further configured to analyze motion videos of the flying ball captured by cameras positioned on both sides of an imaginary line connecting a start point and an end point of a ball flight path and a camera positioned at a predetermined height from the imaginary line to determine the trajectory of the flying ball.

The image rendering module may be further configured to control the different background scenes to be included in the sequence of images of the ball using pre-stored modelling data of a stadium corresponding to the batter's view angle.

The image rendering module may be further configured to analyze an image of the batter captured by one of the plurality of cameras or a separate camera to obtain information on at least one of the batter's height and a position at which the batter is positioned in a batter's box and control the different background scenes to be included in the sequence of images of the ball based on the information.

The image rendering module may be further configured to process the modelling data such that the different background scenes are blurred in the sequence of images of the ball.

The image rendering module may be further configured to overlay the ball over the blurred different background scenes proximate to centers of the blurred different background scenes in the sequence of images of the ball.

The batter's viewpoint may be a viewpoint of eyes of the batter.

The image rendering module may be further configured to process the sequence of images of the ball to have the ball brought into focus in the sequence of images of the ball.

In another general aspect, a method of visualizing a ball trajectory comprises analyzing motion videos of a flying ball captured by a plurality of cameras to determine a trajectory of the flying ball, said trajectory of the flying ball being defined by 3-dimensional coordinates; and rendering a sequence of images of the ball from a batter's viewpoint based on the 3-dimensional coordinates, the rendering comprising controlling different background scenes to be included in the sequence of images of the ball as the ball approaches toward the batter in the sequence of images of the ball.

The rendering may further comprise overlaying the ball over the different background scenes in the sequence of images of the ball.

The analyzing may comprise analyzing motion videos of the flying ball captured by cameras positioned on both sides of an imaginary line connecting a start point and an end point of a ball flight path and a camera positioned at a predetermined height from the imaginary line to determine the trajectory of the flying ball.

The rendering may further comprise controlling the different background scenes to be included in the sequence of images of the ball using pre-stored modelling data of a stadium corresponding to the batter's view angle.

The rendering may further comprise analyzing an image of the batter captured by one of the plurality of cameras or a separate camera to obtain information on at least one of the batter's height and a position at which the batter is positioned in a batter's box and control the different background scenes to be included in the sequence of images of the ball based on the information.

The rendering may further comprise processing the modelling data such that the different background scenes are blurred in the sequence of images of the ball.

The rendering may further comprise overlaying the ball over the blurred different background scenes proximate to centers of the blurred different background scenes in the sequence of images of the ball.

The batter's viewpoint may be a viewpoint of eyes of the batter.

The rendering may further comprise processing the sequence of images of the ball to have the ball brought into focus in the sequence of images of the ball.

Other features and aspects will be apparent from the following detailed description, the drawings, and the claims.

### BRIEF DESCRIPTION OF THE DRAWINGS

FIG. 1 is a block diagram of an exemplary apparatus for visualizing a ball trajectory.

FIGS. 2 to 4 are exemplary diagrams to illustrate a change of backgrounds in tracking a ball.

FIG. 5 is a diagram to illustrate one example of an epipolar geometric structure.

FIG. 6 is a diagram to illustrate coordinate systems in image geometry.

FIG. 7 is a diagram for describing an exemplary method of finding 8 matching pairs of sets of image coordinates inputted in the process of calculating matrix F.

FIG. 8 is a diagram to illustrate an exemplary enlarged image of a ball pitched by a pitcher.

FIG. 9 is a flowchart for illustrating an exemplary method for visualizing a ball trajectory.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in understanding various examples of the methods, apparatuses, and/or systems described herein. Various changes, modifications, and equivalents of the methods, apparatuses, and/or systems will be apparent based on the various examples described herein. For example, the sequences of operations described herein are merely examples, and are not limited to those set forth herein, but may be changed.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, or regions, these members, components, or regions are not to be limited by these terms. Rather, these terms are only used to distinguish one member, component, or region from another member, component, or region. Thus, a first member, component, or region referred to in examples described herein may also be referred to as a second member, component, or region without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

The features of the examples described herein may be combined in various ways as will be apparent after an understanding of the disclosure of this application. Further, although the examples described herein have a variety of configurations, other configurations are possible as will be apparent after an understanding of the disclosure of this application.

This patent document provides various implementations to visualize a trajectory of a ball pitched by a pitcher in a way that a viewer can feel more real and present as if he is in the scene. In one aspect, the disclosed technology provides visualizing a trajectory of a ball pitched by a pitcher as an image from a batter's or catcher's viewpoint instead of pitcher's. In broadcasting a baseball game, if a ball pitched by a pitcher is visualized and displayed from a batter's or a catcher's viewpoint, a viewer can feel a more realistic and immersive experience. For example, the viewer can even feel the speed of the ball and identify how well the pitch was thrown. In this document, various examples and implementations are described in detail. These include, for example, detecting an angle of rotation and rendering images from a batter's or catcher's viewpoint. These and other examples are described in more detail below with reference to the appended drawings.

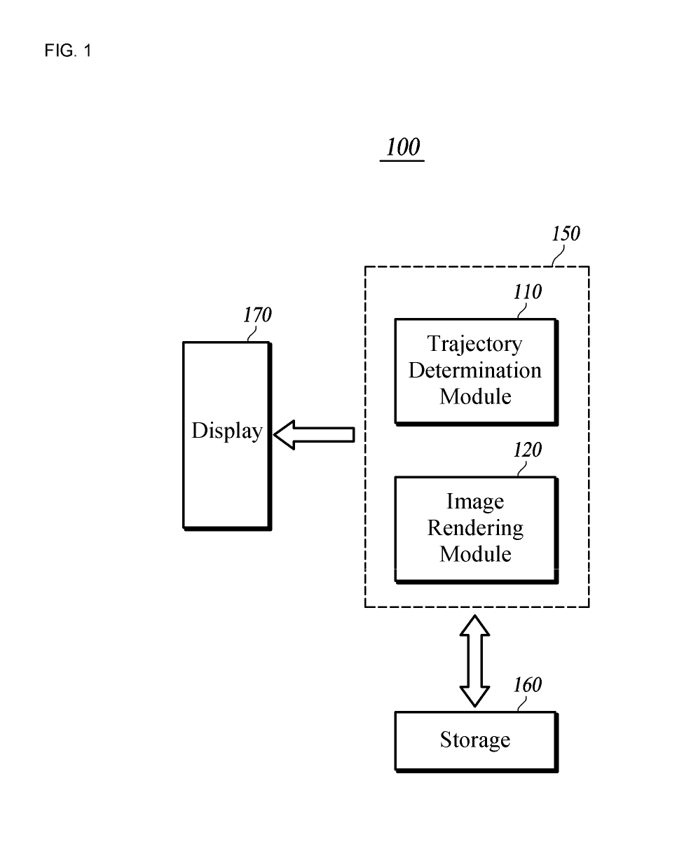

FIG. 1 is a block diagram of an apparatus for visualizing a ball trajectory in an example.

As shown in FIG. 1, an exemplary apparatus 100 for visualizing a ball trajectory may include a controller 150, a storage 160, and a display 170. The controller 150 may be arranged to communicate with the storage 160 and the display 170 and configured to perform the process of visualizing a ball 10 with images from a viewpoint of someone other than a pitcher. As an example, the apparatus will be firstly discussed to provide the visualization of the ball from a batter's viewpoint but the disclosed technology is not limited thereto. The controller 150 may include a trajectory determination module 110 and an image rendering module 120. The trajectory determination module 110 may be configured to obtain and analyze a sequence of images of a flying ball 10 which moves along a trajectory 20. The sequence of images captured by a plurality of cameras is used to determine the trajectory 20 of the flying ball 10. The trajectory 20 of the flying ball 10 may be defined by multiple sets of 3-dimensional coordinates. The plurality of cameras may each include an imaging device and serve to convert light into an image signal. The plurality of cameras may be installed at predetermined positions in a baseball stadium to capture a video image of the flying ball 10 to thereby provide ball image data.

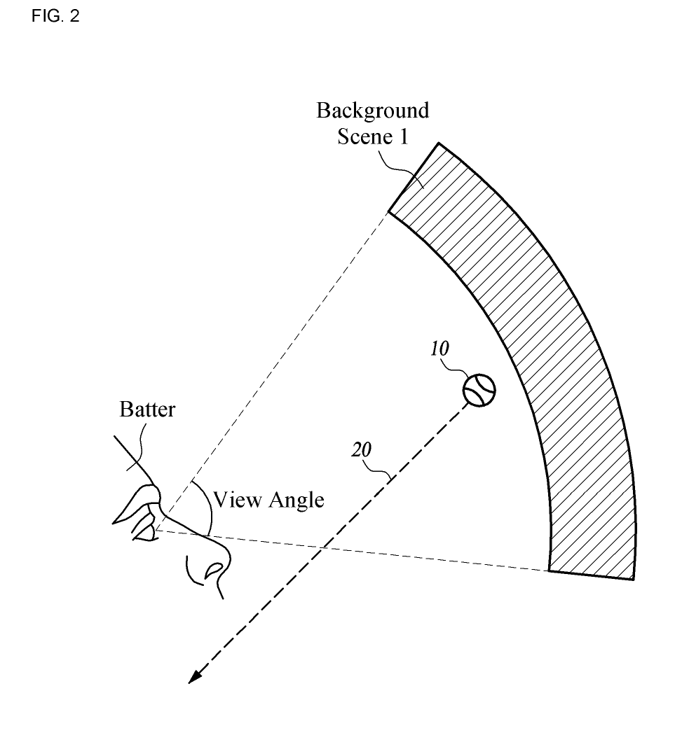

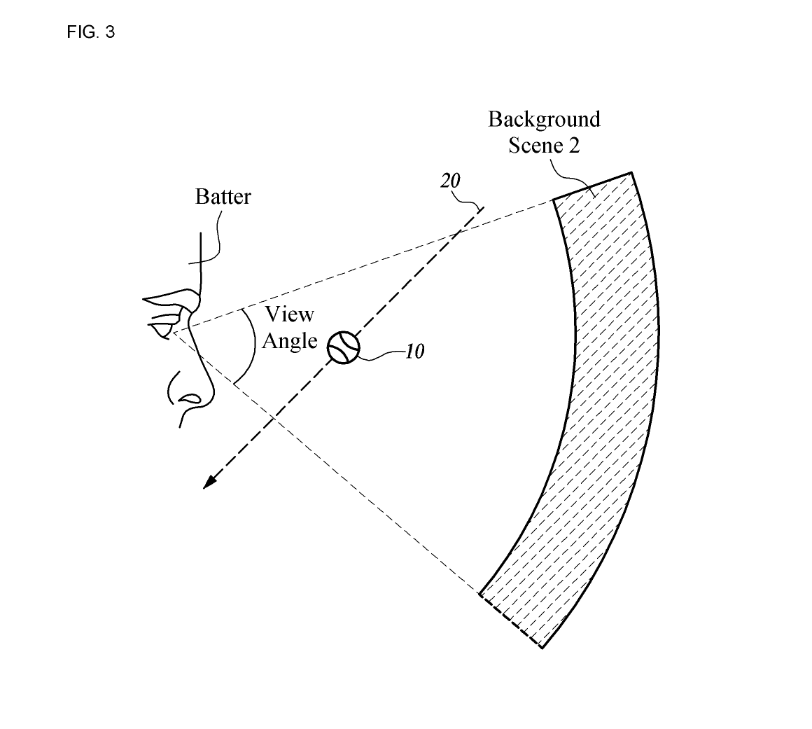

As shown in FIGS. 2 to 4, when a pitcher pitches the ball 10 toward a catcher, a batter watches the ball 10 as well as background scenes while tracking the ball 10 approaching toward the batter. As the batter's eyes move along the trajectory 20 of the ball 10, the background scene watched by the batter may be changed from Background Scene 1 to Background Scene 2 and to Background Scene 3. The trajectory determination module 110 may be configured to determine multiple sets of 3-dimensional coordinates that define the trajectory 20 of the ball 10. Each set of 3-dimensional coordinates may be assigned to each of image frames or image fields that constitute the sequence of images of the ball 10. In some implementations, the trajectory determination module 110 may be configured to derive the trajectory 20 of the ball 10 based on epipolar geometry, a fundamental matrix, and an image geometry. The epipolar geometry will be described below with reference to the drawings.

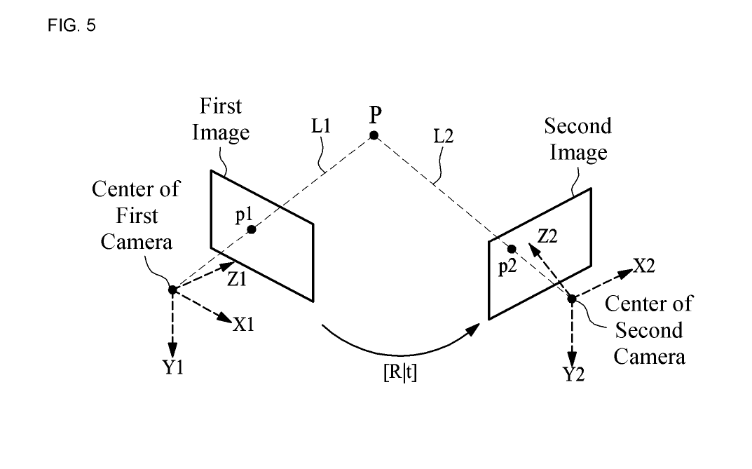

The epipolar geometry is the geometry of stereo vision. When cameras view a 3D scene from two distinct positions, there are a number of geometric relations between the 3D points and their projections. If intrinsic parameters and extrinsic parameters are determined in a stereo imaging system equipped with the plurality of cameras, it is possible to geometrically predict onto which point in a stereo image each set of 3-dimensional spatial coordinates is projected. The intrinsic parameters may include a focal length, a pixel size, and the like of each of the plurality of cameras. The extrinsic parameters may define spatial conversion relationships between the plurality of cameras, such as a rotation and a movement of each of the plurality of cameras. Such geometric corresponding relationships between the stereo images are referred to as an epipolar structure. FIG. 5 is a diagram to illustrate one example of an epipolar geometric structure formed between the stereo images obtained from the two cameras. The epipolar geometric structure geometrically defines a relation regarding how a point in a stereo image is projected on another stereo image. This will be described in more detail below with reference to FIG. 5.

Referring to FIG. 5, a first camera and a second camera provide a first image and a second image, respectively, and a single point P is projected on the first image and the second image. The single point P is assumed to be projected onto a single point p1 on the first image in a 3-dimensional space. When viewing from the first image, all spatial points on a first straight line L1 connecting the center of a first camera to the single point P in the 3-dimensional space may be projected onto the same single point p1. On the other hand, the single point P and the points on the first straight line L1 in the 3-dimensional space are projected onto different positions on a second image. Thus, the points in the 3-dimensional space, which are projected onto the single point p1 on the first image, are projected onto a straight line in the second image. When a lens of the camera produces a nonlinear distortion, the points in the 3-dimensional space may be projected onto a curved line in the second image. As described above, for the single point p1 projected in the first image, a single point cannot be exactly defined in the second image. The points projected in the first image form the geometric straight line L1. Similarly, the points projected in the second image form a geometric straight line L2. Such a straight line structure is referred to as an epipolar straight line. In estimating a corresponding relation between the stereo images, i.e., the first image and the second image, the epipolar straight line and the epipolar geometric structure may be used to geometrically convert a position of an arbitrary point in the first image or second image into a position in the second or first image. That is, when images of the same object or scene are acquired at two different locations, the epipolar geometric structure defines a geometric relation between the coordinates in the first image and those in the second image.

Such epipolar geometric structure may be expressed by a fundamental matrix. The fundamental matrix is a matrix that represents a geometric relation(s) between pixel coordinates in the first image and pixel coordinates in the second image, such geometric relation including the parameters of the camera. A matrix F satisfying the following Equations 1 and 2 are always present between pixel coordinates p_{img} (=p1) in the first image and pixel coordinates p_{img′} (=p2) in the second image. Such matrix F is referred to as a fundamental matrix.

$$\begin{matrix}{p}_{img}^{′ T} {Fp}_{img} = 0 & Equation 1 \\ [ {x}^{′} {y}^{′} 1 ] F [ \begin{matrix}x \\ y \\ 1\end{matrix} ] = 0 & Equation 2\end{matrix}$$

When an intrinsic parameter matrix for the first camera in connection with the first image is K, an intrinsic parameter matrix for the second camera in connection with the second image is K′, and an essential matrix between the first image and the second image is E, the fundamental matrix F is represented as the following Equations 3 and 4.

E=K′^{T}FK Equation 3

F=(K′^{T})⁻¹EK⁻¹ Equation 4

Eight or more matching pairs of sets of image coordinates may be inputted for the fundamental matrix F. In this case, each set of image coordinates may have two-dimensional image coordinates including an x coordinate and a y coordinate. For example, a coordinate pair, which includes the coordinates of p1 and the coordinates of p2 in FIG. 5, may be a matching pair of sets of image coordinates.

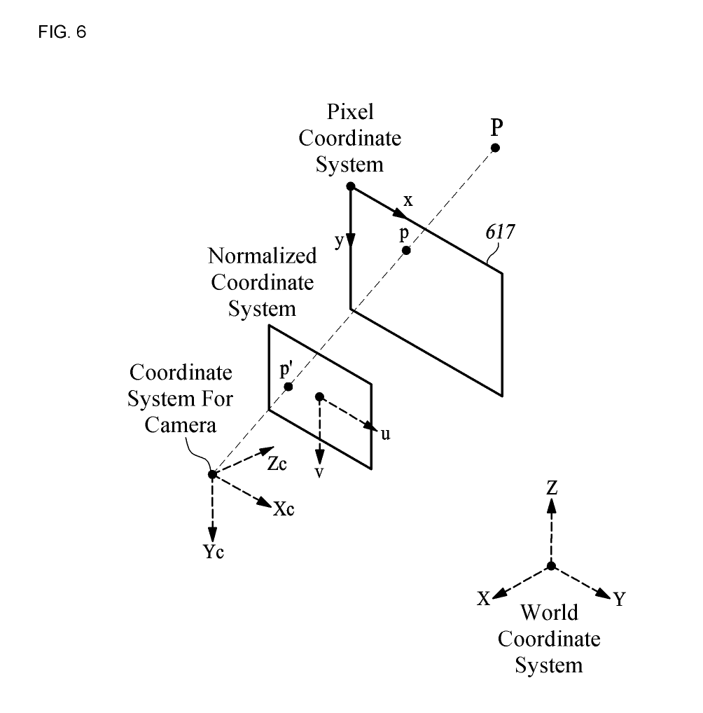

FIG. 6 is a diagram to illustrate exemplary coordinate systems of an image geometry. The image geometry may be employed to reflect a view angle, a focal length, and a degree of distortion for each of the image forming modules such as cameras. In FIG. 6, a world coordinate system, a pixel coordinate system, and a normalized coordinate system are shown. When T is a matrix that converts a single point (X, Y, Z) in the world coordinate system into a point (x, y) in an image plane 617 in the pixel coordinate system, its relation may be defined by Equation 5 in terms of homogeneous coordinates.

$$S [ \begin{matrix}x \\ y \\ 1\end{matrix} ] = T [ \begin{matrix}X \\ Y \\ Z \\ 1\end{matrix} ] \qquad Equation 5$$

In Equation 5, T is a 4×3 matrix and may be decomposed and represented as the following Equations 6 and 7.

$$\begin{matrix}S [ \begin{matrix}x \\ y \\ 1\end{matrix} ] = {KT}_{pers} ( 1 ) [ R \vert t ] [ \begin{matrix}X \\ Y \\ Z \\ 1\end{matrix} ] & Equation 6 \\ S [ \begin{matrix}x \\ y \\ 1\end{matrix} ] = [ \begin{matrix}{f}_{x} & 0 & {c}_{x} \\ 0 & {f}_{y} & {c}_{y} \\ 0 & 0 & 1\end{matrix} ] [ \begin{matrix}1 & 0 & 0 & 0 \\ 0 & 1 & 0 & 0 \\ 0 & 0 & 1 & 0\end{matrix} ] [ \begin{matrix}{r}_{11} & {r}_{12} & {r}_{13} & {t}_{x} \\ {r}_{21} & {r}_{22} & {r}_{23} & {t}_{y} \\ {r}_{31} & {r}_{32} & {r}_{33} & {t}_{z} \\ 0 & 0 & 0 & 1\end{matrix} ] [ \begin{matrix}X \\ Y \\ Z \\ 1\end{matrix} ] & Equation 7\end{matrix}$$

In Equation 6, [R|t] is an extrinsic parameter of the camera, the extrinsic parameter being a rigid transformation matrix that converts the world coordinate system into a plurality of coordinate systems for the camera, Tₚₑᵣₛ(1) is a projection matrix that projects 3-dimensional coordinates in the coordinate system for the camera onto a normalized image plane, and K is an intrinsic parameter matrix for the camera and is used to convert normalized image coordinates into pixel coordinates. Tₚₑᵣₛ(1) is a projection transformation to a plane where the relation Zc=1, i.e., d=1 holds. Therefore, the matrix T, which converts the single point (X, Y, Z) in the world coordinate system into the point (x, y) in an image plane, i.e., in the pixel coordinate system is represented as the following simplified Equation 8.

$$S [ \begin{matrix}x \\ y \\ 1\end{matrix} ] = K [ R \vert t ] [ \begin{matrix}X \\ Y \\ Z \\ 1\end{matrix} ] \qquad Equation 8$$

A correlation between the world coordinate system (X, Y, Z) and the pixel coordinate system (x, y) for each of the plurality of cameras may be derived through the above-described image geometry, and a correlation between the plurality of cameras may be determined through the fundamental matrix F. Through such fundamental matrix F and such image geometry, the trajectory 20 of the ball 10 may be derived. That is, when each of the plurality of cameras generates a motion image of 50 frames per second, a position of the ball 10 may be set for each of the 50 frames through the fundamental matrix F and the relational expression for the above-described matrix T. When the positions of the ball 10 in the 50 image frames are connected to one another, the trajectory 20 of the ball 10 may be derived. In an example, the origin of the world coordinate system may correspond to a home base of a baseball stadium at which the plurality of cameras are installed.

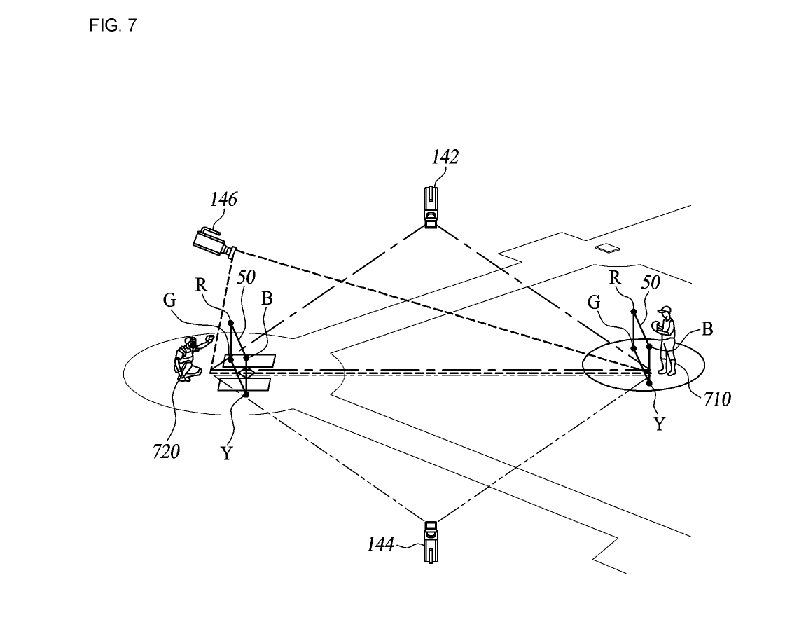

FIG. 7 is a diagram to illustrate an exemplary method of finding 8 matching pairs of sets of image coordinates inputted in the process of calculating matrix F. A square frame 50 is installed, and a red light emitting diode (LED) R, a blue LED B, a green LED G, and a yellow LED Y are mounted on the respective vertices of the square frame 50. It is assumed that the actual coordinates of each of the vertices are known in the world coordinate system. When the fundamental matrix F is calculated based on the actual coordinates, a direction and a movement of each of the plurality of cameras 142, 144, 146 may be calculated. Thereafter, the coordinates (x, y) of the ball 10 in an image captured by each of the plurality of cameras 142, 144, 146 may be represented in terms of the corresponding world coordinate (X, Y, Z).

As one implementation shown in FIG. 7, the trajectory determination module 110 may derive the trajectory 20 of the ball 10 through the three cameras 142, 144, 146. The two cameras 142, 144 among the three cameras 142, 144, 146 may be positioned on both sides of an imaginary line connecting a start point and an end point of a ball flight path. The start point of the ball flight path may be placed at a position of a pitcher 710, and the end point of the ball flight path may be placed at a position of a catcher 720. Also, the remaining one 146 among the three cameras 142, 144, 146 may be positioned at a predetermined height from the imaginary line. The trajectory 20 of the ball 10 pitched by the pitcher 710 may vary vertically and/or horizontally according to the quality and type of the pitch. Therefore, the cameras 142,144 positioned at the left and right sides of the imaginary line are suitable for imaging a trajectory 20 of the ball 10 that varies vertically, and the camera 146 positioned at the upper position of the imaginary line is suitable for imaging a trajectory 20 of the ball 10 that varies horizontally. Each of the plurality of cameras 142, 144, 146 captures images of the 8 LEDs, and a position of each of the 8 LEDs is preset in the world coordinate system. Thus, the fundamental matrix F between the left side camera 142 and the upper side camera 146 may be derived, and the fundamental matrix F between the right side camera 144 and the upper side camera 146 may also be derived. The trajectory determination module 110 may derive the trajectory 20 of the ball 10 according to the fundamental matrix F between the two cameras based on a position of the ball 10 in each of the images generated by the two cameras among the plurality of cameras 142, 144, 146. One of the two fundamental matrices F or an average thereof may be used to derive the trajectory 20 of the ball 10. If the average of the two fundamental matrices F is used to derive the trajectory 20 of the ball 10, the trajectory 20 of the ball 10 may be more accurately derived.

As is described above, the cameras 142, 144 positioned at the left and right sides of the imaginary line are suitable for imaging the trajectory 20 of the ball 10 that varies vertically, and the camera 146 positioned at the upper position of the imaginary line is suitable for imaging the trajectory 20 of the ball 10 that varies horizontally. Consequently, the trajectory determination module 110 may derive a trajectory of a ball based on a fundamental matrix between the camera 142 or 144 positioned at either side of the imaginary line and a camera 146 positioned at a predetermined height from the imaginary line, and a fundamental matrix between the camera 144 or 142 positioned at the other side of the imaginary line and the camera 146 positioned at the predetermined height from the imaginary line. Although an example in which the trajectory determination module 110 determines the trajectory 20 of the flying ball 10 has been described above, it should be understood that the way the trajectory 20 of the ball 10 is determined is not limited to such example.

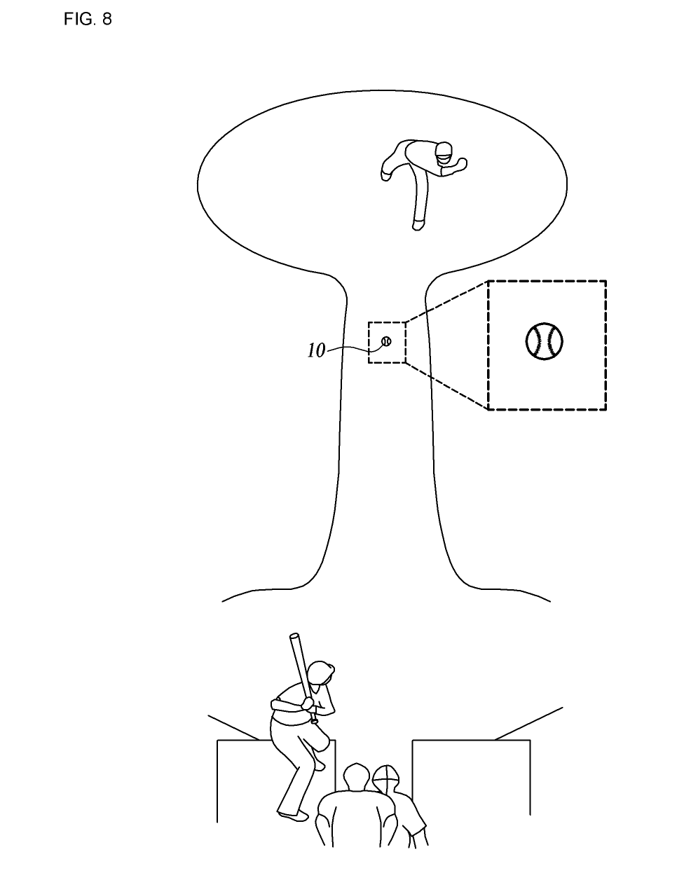

FIG. 8 is a diagram to illustrate an enlarged image of a ball pitched by a pitcher in an example. A region representing the ball 10 may be detected using a difference in gradation level between the ball 10 and the background scene around the ball 10. After the region representing the ball 10 is detected, the center point coordinates (x, y) of the ball 10 (in the image coordinate system) may be modified through subpixel interpolation. Such center point coordinates (x, y) may correspond to the coordinates of the point p1 or the point p2 in FIG. 5. Because the camera typically generates several tens of frames per second, as is described above, the trajectory 20 of the ball 10 between the frames may be derived through, for example, the Kalman filter. The Kalman filter is applicable when a probabilistic error is present in a measured value of an object and a state of the object at a specific time has a linear relation with a previous state thereof. In the case of tracking the trajectory 20 of the ball 10, a position of the ball 10 and a speed and acceleration of the ball per section may be measured, but an error may be present in these measured values. In this case, the positions of the ball 10 may be estimated by filtering continuously measured values using the Kalman filter. The trajectory 20 of the ball 10 may be derived by applying interpolation to the estimated positions of the ball 10.

Referring back to FIG. 1, the controller 150 may further include an image rendering module 120. The image rendering module 120 is coupled to the trajectory determination module 110. The image rendering module 120 may be configured to render a sequence of images of the ball 10 from the batter's viewpoint based on multiple sets of 3-dimensional coordinates, which define the trajectory 20 of the flying ball 10 that is determined by the trajectory determination module 110. The image rendering module 120 is further coupled to the display 170 to allow the rendered sequence of images of the ball 10 to be displayed on the display 170. In an example, the batter's viewpoint may be a viewpoint of the eyes of the batter. In some implementations, the batter's viewpoint may refer to a viewpoint of other parts of the batter. As is described in conjunction with FIGS. 2 to 4, some implementations of the disclosed technology provide rendering a sequence of images together with background scenes that change as the ball moves toward the batter. For example, the image rendering module 120 may be configured to control different background scenes to be displayed in the sequence of images of the ball 10 as the ball 10 approaches toward the batter in the sequence of images of the ball 10. In an example, the image rendering module 120 may further be configured to control the ball 10 to be overlaid and displayed with the different background scenes in the sequence of images of the ball 10. The background scene around the ball 10 may vary according to the batter's view angle. In consideration of this, the image rendering module 120 may be further configured to control the different background scenes to be displayed in the sequence of images of the ball 10 using pre-stored modeling data of an actual stadium that match with the batter's view angle.

When the batter tracks a movement of a ball 10, the eyes of the batter may be focused on the ball 10 that is moving. Some implementations of the disclosed technology includes processing background scenes in a way that a viewer can more focus on the ball than the background scenes. For example, as the batter mostly focuses on the moving ball, the background scenes are treated to have different quality from the original background scenes. In some implementations, the background scenes around the ball 10 appear blurry to the batter. To provide such an effect, the image rendering module 120 may be configured, in an example, to process the modeling data such that the different background scenes are blurred in the sequence of images of the ball 10. Also, the eyes of the batter are focused on the moving ball 10 itself rather than the background scenes when tracking the movement of the ball 10. To provide such an effect, the image rendering module 120 may be configured to process the sequence of images of the ball 10 to control the ball 10 to be overlaid and displayed at the centers of the blurred different background scenes, thereby allowing the viewer to more focus on the ball 10 rather than the background scenes. In this manner, the image rendering module 120 provides the sequence of images such that the ball 10 is displayed more clearly compared to the blurred different background scenes.

In an example, the image rendering module 120 may be further configured to analyze an image of the batter captured by one of the plurality of cameras 142, 144, 146 or a separate camera to obtain information on at least one of the batter's height and a position at which the batter is positioned in a batter's box and control the different background scenes to be displayed in the sequence of images of the ball 10 based on the information. For this, the image rendering module 120 is coupled to the plurality of cameras 142, 144, 146 or the separate camera. In this example, the image rendering module 120 may be configured to detect a region representing the batter in the image of the batter using, for example, clustering, contour detection, and the like and detect a vertical length of the detected region to estimate the batter's height based on the detected vertical length. The image rendering module 120 may render the sequence of images of the ball 10 from a viewpoint that is adjusted according to the estimated batter's height. Also, the image rendering module 120 may detect a region representing the batter's box and a region representing the batter from the image of the batter and render the sequence of images of the ball 10 from a viewpoint that is adjusted according to a positional relation between the two detected regions.

In an example, the image rendering module 120 may be further configured to display a virtual pitcher at a start position of the trajectory 20 of the ball 10 in the sequence of images of the ball 10. The virtual pitcher may be implemented by extracting a contour of the real pitcher from an image of the real pitcher that is obtained from one or more cameras installed at the rear of a real catcher.

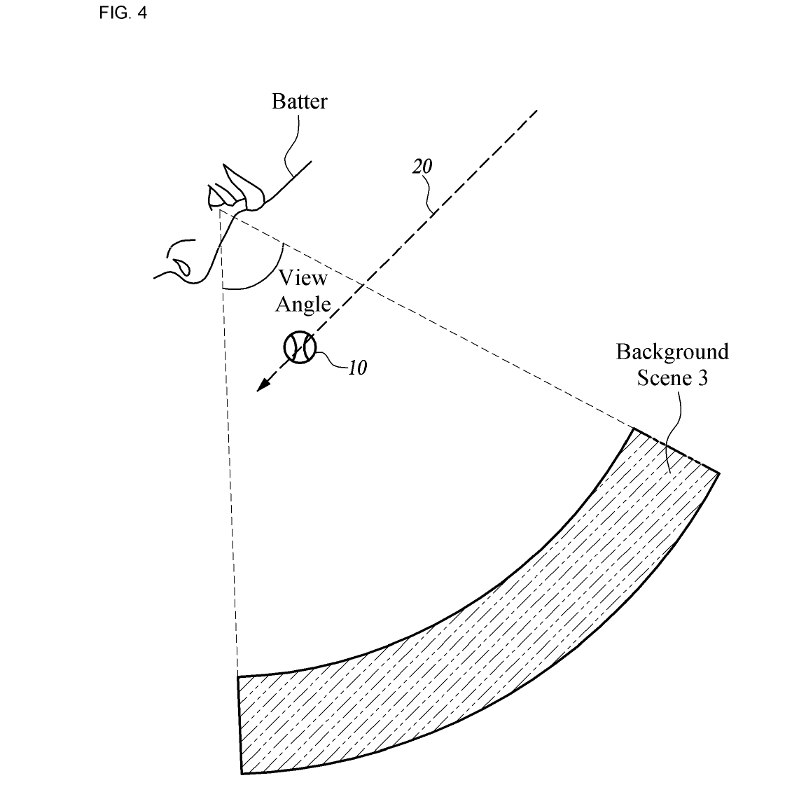

As shown in FIGS. 2 to 4, when the batter tracks the ball 10, the speed at which the batter's eyes track the ball 10 is increased as the ball 10 approaches toward the batter. That is, if the pitcher pitches the ball 10, the batter may visually feel that the speed of the ball 10 is increasing as the ball 10 approaches toward the batter. The batter's eyes more focus on the ball 10 as the ball 10 approaches toward the batter, and thus Background Scene 3 in FIG. 4 in which the ball 10 is in proximity to the batter may appear to be blurrier to the batter compared to Background Scene 1 in FIG. 2 in which the ball 10 begins to move. Further, in some examples, the blurred region is greater in Background Scene 3 than Background Scene 1. To implement such an effect, the image rendering module 120 may use an n2×m2 mask for performing a blurring process on the modeling data corresponding to Background Scene 3 after using an n1×m1 mask for performing a blurring process on the modeling data corresponding to Background Scene 1. Because the blurred region in Background Scene 3 is greater than that in Background Scene 1, n2 may be greater than n1 if m1 is equal to m2. The masks may be used for suitable calculation techniques including convolution calculation with the modeling data corresponding to the background scenes. In the blurring process, the convolution calculation through the masks is well known to those skilled in the art so that a detailed description thereof will be omitted.

In terms of hardware, the above-described controller 150 may be implemented using at least one among application specific integrated circuits (ASICs), digital signal processors (DSPs), digital signal processing devices (DSPDs), programmable logic devices (PLDs), field-programmable gate arrays (FPGAs), processors, controllers, micro-controllers, and microprocessors. The image rendering module 120 may also be implemented as a firmware/software module that is executable on the above-described hardware platform. In this case, the firmware/software module may be implemented by one or more software applications written in a suitable program language. In an example, the image rendering module 120 may be implemented using an open graphics library (OpenGL) program.

The storage 160 is used to store image data provided as a result of various image processing performed by the image rendering module 120, and software and/or firmware for controlling an operation of the controller 150. The storage 160 may be implemented by one storage medium among a memory card including a flash memory type memory card, a hard disk type memory card, a multimedia card (MMC) type memory, a card type memory (for example, a secure digital (SD) memory card, an extreme digital (XD) memory card, etc.), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk, but is not limited thereto.

The display 170 is configured to display the sequence of images of the ball 10, which is provided according to the various examples described above. The display 170 may include various display devices such as a liquid crystal display (LCD), a light emitting diode (LED) display, an active matrix organic LED (AMOLED) display, a cathode-ray tube (CRT) display, and the like.

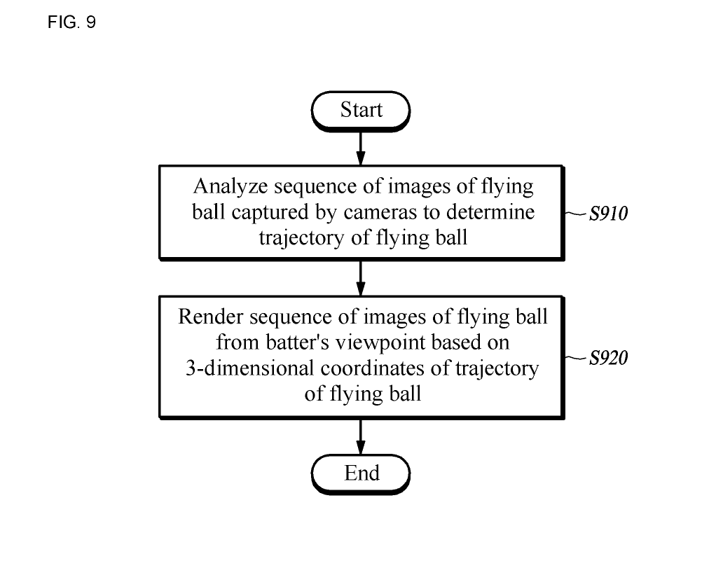

FIG. 9 is a flowchart to illustrate an exemplary method for visualizing a ball trajectory in an example.

As shown in the drawing, the method for visualizing a ball trajectory according to an example begins in operation S910 of analyzing a sequence of images of a flying ball 10 captured by a plurality of cameras 142, 144, 146 to determine a trajectory 20 of the flying ball 10. The trajectory 20 of the flying ball 10 may be defined by multiple sets of 3-dimensional coordinates. In an example, it is possible to analyze the sequence of images of the flying ball 10 captured by the cameras 142, 144 positioned on both sides of an imaginary line connecting a start point and an end point of a ball flight path and the camera 146 positioned at a predetermined height from the imaginary line to determine the trajectory 20 of the flying ball 10.

In operation S920, the sequence of images of the ball 10 is rendered from the batter's viewpoint based on the multiple sets of 3-dimensional coordinates that define the trajectory 20 of the flying ball 10. In an example, the batter's viewpoint may be a viewpoint of the eyes of the batter. In an example, the sequence of images of the ball 10 may be rendered such that different background scenes are provided in the sequence of images as the ball 10 approaches toward the batter. In an example, the different background scenes may be displayed in the sequence of images of the ball 10 by overlaying the ball 10 with the different background scenes. In an example, the different background scenes may be displayed in the sequence of images of the ball 10 using pre-stored modeling data of a virtual or actual stadium that match with the batter's view angle. In an example, an image of the batter captured by one of the plurality of cameras 142, 144, 146 or a separate camera may be analyzed to obtain information on at least one of a batter's height and a position at which the batter is positioned in a batter's box. Such information may be used in controlling the different background scenes to be displayed in the sequence of images of the ball 10. In an example, the modeling data may be processed to control the different background scenes to be blurred in the sequence of images of the ball 10. In an example, the ball 10 may be overlaid over and displayed on the centers of the blurred different background scenes in the sequence of images of the ball 10. In an example, the sequence of images of the ball 10 may be processed to have the ball 10 brought into focus in the sequence of images of the ball 10.

Hereinabove, although the examples in which the sequence of images of the ball 10 is rendered from the batter's viewpoint have been described, it should be understood that an example in which the sequence of images of the ball 10 is rendered from a catcher's viewpoint may be possible. In such an example, the sequence of images of the ball 10 may be displayed using pre-stored modeling data of the virtual or actual stadium that match with the catcher's viewpoint.

In accordance with the examples disclosed above, the contents of the baseball game can be realistically delivered to the viewer by visualizing and displaying a trajectory of a ball pitched by a pitcher from the batter's viewpoint in association with different background scenes.

In the examples disclosed herein, the arrangement of the illustrated components may vary depending on an environment or requirements to be implemented. For example, some of the components may be omitted or several components may be integrated and carried out together. In addition, the arrangement order of some of the components can be changed.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An apparatus for visualizing a ball trajectory, comprising:
a trajectory determination module configured to receive captured images of a ball that is moving and determine a trajectory of the ball, said trajectory of the ball being defined by 3-dimensional coordinates; and
an image rendering module coupled to the trajectory determination module and configured to render a sequence of images of the ball from a batter's viewpoint based on the 3-dimensional coordinates,
said image rendering module being further configured to include different background scenes in the sequence of images of the ball as the ball approaches toward the batter in the sequence of images of the ball.

2. The apparatus of claim 1, wherein said image rendering module is further configured to overlay the ball with the different background scenes in the sequence of images of the ball.

3. The apparatus of claim 1, wherein said trajectory determination module is configured to receive the captured images from cameras positioned on both sides of an imaginary line connecting a start point and an end point of a ball flight path and a camera positioned at a predetermined height from the imaginary line.

4. The apparatus of claim 1, wherein said image rendering module is further configured to use pre-stored modelling data of a stadium corresponding to the batter's view angle.

5. The apparatus of claim 4, wherein said image rendering module is further configured to obtain information on at least one of the batter's height and a position at which the batter is positioned in a batter's box and control the different background scenes to be included in the sequence of images of the ball based on the information.

6. The apparatus of claim 4, wherein said image rendering module is further configured to process the modelling data such that the different background scenes are blurred in the sequence of images of the ball.

7. The apparatus of claim 6, wherein said image rendering module is further configured to overlay the ball with the blurred different background scenes proximate to centers of the blurred different background scenes in the sequence of images of the ball.

8. The apparatus of claim 1, wherein the batter's viewpoint is a viewpoint of eyes of the batter.

9. The apparatus of claim 7, wherein said image rendering module is further configured to process the sequence of images of the ball to provide more focus to the ball in the sequence of images of the ball as compared to the background scenes.

10. A method of visualizing a ball trajectory, comprising:
analyzing motion videos of a flying ball captured by a plurality of cameras to determine a trajectory of the flying ball, said trajectory of the flying ball being defined by 3-dimensional coordinates; and
rendering a sequence of images of the ball from a batter's viewpoint based on the 3-dimensional coordinates,
the rendering comprising controlling different background scenes to be included in the sequence of images of the ball as the ball approaches toward the batter in the sequence of images of the ball.

11. The method of claim 10, wherein the rendering further comprises overlaying the ball with the different background scenes in the sequence of images of the ball.

12. The method of claim 10, wherein the analyzing comprises analyzing motion videos of the flying ball captured by cameras positioned on both sides of an imaginary line connecting a start point and an end point of a ball flight path and a camera positioned at a predetermined height from the imaginary line to determine the trajectory of the flying ball.

13. The method of claim 10, wherein the rendering further comprises using pre-stored modelling data of a stadium corresponding to the batter's view angle.

14. The method of claim 13, wherein the rendering further comprises obtaining information on at least one of the batter's height and a position of the batter in a batter's box.

15. The method of claim 13, wherein the rendering further comprises processing the modelling data such that the different background scenes are blurred in the sequence of images of the ball.

16. The method of claim 15, wherein the rendering further comprises overlaying the ball over the blurred different background scenes proximate to centers of the blurred different background scenes in the sequence of images of the ball.

17. The method of claim 10, wherein the batter's viewpoint is a viewpoint of eyes of the batter.

18. The method of claim 16, wherein the rendering further comprises processing the sequence of images of the ball to provide more focus to the ball in the sequence of images of the ball as compared to the background scenes.
